(19) United States
(12) Patent Application Publication
(10) Pub. No.: US 2026/0292426 A1
(43) Pub. Date: Sep. 24, 2026

(54) PORTABLE LOCATING-ENABLED AUDIO PLAYING DEVICE AND SYSTEM, AND DATA MANAGEMENT METHOD

(71) Applicant: SHENZHEN MILESEEY TECHNOLOGY CO., LTD., SHENZHEN (CN)

(72) Inventors: Long Luo, SHENZHEN (CN); Zhi Chou, SHENZHEN (CN)

(21) Appl. No.: 19/083,423

(22) Filed: Mar. 18, 2025

(51) Int. Cl. H04S 7/00; G01S 19/19

(52) U.S. Cl. CPC H04S 7/00; G01S 19/19

(57) ABSTRACT

A portable locating-enabled audio playing device includes: a portable locating body and an audio playing body. The portable locating body includes a first processing module, a GPS module and a display module. The GPS module obtains GPS locating information of the portable locating body; the display module displays map information and the GPS locating information; the GPS locating information includes a locating marker on the map information. The audio playing body includes a second processing module and a second playing module; the second playing module is connected to the first processing module when the audio playing body and the portable locating body are connected to each other; the second processing module obtains information data transmitted from the first processing module; and controls the second playing module to play audio data. The second processing module and the first processing module transmit the information data.

### TECHNICAL FIELD

The present disclosure relates to the technical field of tools for locating, and particularly to a portable locating-enabled audio playing device and system, and a data management method.

### BACKGROUND

As science and technology develop, audio playing devices are increasingly widely used in golf courses. However, there are various technical problems with the audio playing devices in the art, limiting performance thereof and improvement in user experience. Specific technical problems are as follows.
1. The audio playing devices are highly depending on mobile phones, which provide GPS positioning information. The audio playing devices obtain positioning data through applications installed in the mobile phones, such that a user may be unable to use the audio playing device properly without the mobile phone. Therefore, independence and portability of the audio playing device is limited.
2. The audio playing devices are lack of visualization information. Some audio playing devices in the art are not arranged with any visualizable screen, or a screen of the audio playing device has simple functions only and cannot display map information. The user is unable to visualize a location of the user and surrounding environments, such that usefulness of the audio playing device is reduced.
3. A loudspeaker of the audio playing device operates at a low power and has poor sound quality. Since the audio playing device has a small size, the power of the loudspeaker of the audio playing device is generally low, and poor sound quality is provided. When being used in an outdoor environment, especially in a noisy scene, the user may not clearly hear an audio prompt.
4. An insufficient battery life is provided. The battery life of the audio playing device in the art is limited, and demands of the user for long-time use cannot be met. The user may need to charge the audio playing device frequently, such that portability and practicality of the audio playing device is reduced.

In summary, the portable locating-enabled audio playing device in the art has various deficiencies in functions, performance and user experience. Therefore, it is of great practical significance and market demands to develop a new portable locating-enabled audio playing device to solve the above problems.

### SUMMARY

The present disclosure provides a portable locating-enabled audio playing device, including: a portable locating body and an audio playing body. The portable locating body includes a first processing module, a GPS module and a display module. The GPS module is configured to obtain GPS locating information of the portable locating body; the display module is configured to display map information and the GPS locating information under control of the first processing module; the GPS locating information comprises a locating marker on the map information. The audio playing body is detachably connected to the portable locating body. The audio playing body comprises a second processing module and a second playing module; the second playing module is connected to the first processing module when the audio playing body and the portable locating body are connected to each other; the second processing module is configured to: obtain information data transmitted from the first processing module; and control the second playing module to play audio data in the information data. The second processing module transmit the information data to the first processing module.

The present disclosure provides a data management method based on a golf course, performed by the portable locating-enabled audio playing device as described in the above. The portable locating body pre-stores or downloads the map information of the golf course, the map information comprises at least: overall map information of the golf course, golf-hole location information and hazard-region location information; and the data management method includes: obtaining, through the GPS module, the GPS positioning information of the portable locating body; matching latitude and longitude coordinates of the GPS locating information with the overall map information; displaying a map image of the map information in the display module and displaying the locating marker on the map image.

The present disclosure provides a data management method based on a golf course, performed by the portable locating-enabled audio playing device as described in the above. The portable locating body pre-stores or downloads the map information of the golf course, the map information comprises at least: the overall map information of the golf course, the golf-hole location information, and the hazard-region location information; and the data management method includes: presetting an audio playing template; obtaining, through the GPS module, the GPS positioning information of the portable locating body; processing the map information or/and the GPS locating information according to the audio playing template to form audio data based on the map information; and controlling the second playing module to play the corresponding audio data according to a preset rule or a user control signal.

The present disclosure provides a portable locating system, including: the portable locating-enabled audio playing device as described in the above and an external terminal device. The portable locating body of the portable locating-enabled audio playing device is connected to the external terminal device a wireless transmission.

### BRIEF DESCRIPTION OF THE DRAWINGS

Brief introduction of the accompanying drawings for describing the present disclosure is provided below.

FIG. 1 is a structural schematic view of a portable locating-enabled audio playing device according to an embodiment of the present disclosure.

FIG. 2 is a specific implementation of the portable locating-enabled audio playing device according to an embodiment of the present disclosure.

FIG. 3 is a structural schematic view of the portable locating-enabled audio playing device shown in FIG. 2 after being connected to wires.

FIG. 4 is a structural schematic view of a GPS module according to an embodiment of the present disclosure.

FIG. 5 is a structural schematic view of the portable locating-enabled audio playing device, implemented based on contact electrical connection, according to an embodiment of the present disclosure.

FIG. 6 is a structural schematic view of the portable locating-enabled audio playing device, implemented based on connection via a USB interface, according to an embodiment of the present disclosure.

FIG. 7 is a structural schematic view of the portable locating-enabled audio playing device, implemented based on a first battery module and a second battery module, according to an embodiment of the present disclosure.

FIG. 8 is a structural schematic view of the portable locating-enabled audio playing device, implemented based on a battery management circuit and a battery, according to an embodiment of the present disclosure.

FIG. 9 is a structural schematic view of the portable locating-enabled audio playing device, implemented based on a storage module, according to an embodiment of the present disclosure.

FIG. 10 is a structural schematic view of the portable locating-enabled audio playing device, implemented based on a first playing module and a microphone module, according to an embodiment of the present disclosure.

FIG. 11 is a structural schematic view of the portable locating-enabled audio playing device, arranged with a portable locating system, according to an embodiment of the present disclosure.

FIG. 12 is a structural schematic view of the portable locating-enabled audio playing device, arranged with magnetic adsorption structures, according to an embodiment of the present disclosure.

FIG. 13 is a structural schematic view of an audio playing body being magnetically adsorbed to a golf cart according to an embodiment of the present disclosure.

FIG. 14 is a structural schematic view of the portable locating-enabled audio playing device, implemented based on a third interface, according to an embodiment of the present disclosure.

FIG. 15 is a flow chart of a data management method based on GPS information processing, according to an embodiment of the present disclosure.

FIG. 16 is a flow chart of an algorithm of obtaining a distance, according to an embodiment of the present disclosure.

FIG. 17 is a flow chart of the data management method based on audio playing processing, according to an embodiment of the present disclosure.

FIG. 18 is a schematic view of a portable locating system according to a first embodiment of the present disclosure.

FIG. 19 is a schematic view of the portable locating system according to a second embodiment of the present disclosure.

### DETAILED DESCRIPTION

Technical solutions in the embodiments of the present disclosure will be clearly and completely described below with reference to the accompanying drawings.

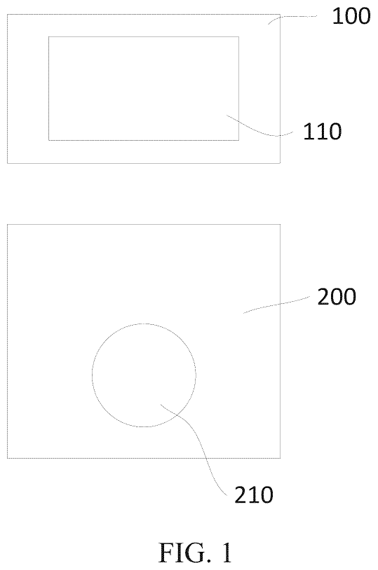

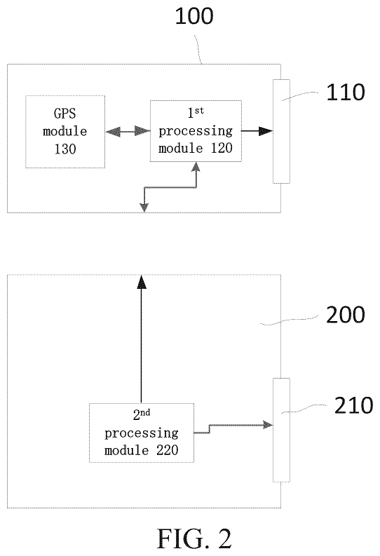

As shown in FIGS. 1 to 6, the present disclosure provides a portable locating-enabled audio playing device. The portable locating-enabled audio playing device includes a portable locating body 100 and an audio playing body 200. The portable locating body 100 includes a first processing module 120, a GPS module 130, and a display module 110. The GPS module 130 obtains GPS locating information of the portable locating body 100. The display module 110 displays, under control of the first processing module 120, map information and GPS locating information. The GPS locating information includes a locating marker on the map information. The portable locating body 100 is detachably connected to the audio playing body 200. The audio playing body 200 includes a second processing module 220 and a second playing module 210. The second processing module 220 is connected to the first processing module 120 when the audio playing body 200 and the portable locating body 100 are connected to each other. The second processing module 220 obtains information data transmitted from the first processing module 120 and controls the second playing module 210 to play audio data in the information data. The second processing module 220 transmits the information data to the first processing module 120. That is, the second processing module 220 and the first processing module 120 are communicatively connected to each other via, such as, wired connection or wireless connection.

Specifically, the first processing module 120 starts the GPS module 130 to start searching for satellite signals to obtain the GPS locating information, and the first processing module 120 simultaneously initializes the display module 110 to display the map information and the locating marker. The GPS module 130 obtaining the GPS locating information of the portable locating body 100, includes obtaining latitude and longitude coordinates. The first processing module 120 matches the obtained GPS locating information with pre-stored or downloaded map information. The first processing module 120 controls the display module 110 to display the map information and display the locating marker on a map to indicate a current location. The user may arrange wired connection between the audio playing body 200 and the portable locating body 100. After the connection, the second processing module 220 establishes communicative connection with the first processing module 120, and the first processing module 120 transmits the audio data to the second processing module 220. The information data includes the pre-stored or downloaded map information of the golf course, a pre-stored or downloaded audio file, and the GPS locating information generated by the GPS module 130. The audio data is formed by processing and converting the information data, meeting requirements for being played.

While in use, the GPS module 130 continuously obtains new locating information and updates the locating marker in real time. The first processing module 120 dynamically adjusts contents of an audio prompt based on the updated locating information, especially in the golf course, the contents of the audio prompt may include a change in a distance from a golf ball to a golf hole. Furthermore, the display module 110 of the portable locating body 100 includes a touch display, and the user may touch the display to perform interactive operations, such as zooming in or out of the map, querying specific location information, and so on. The user may detach the audio playing body 200 from the portable locating body 100 as needed. After detachment, the portable locating body 100 may still operate independently, be portable, and continue to locate and display the map. The audio playing body 200 can operate independently to play the pre-stored audio file or to obtain audio data through other devices.

In the present embodiment, the portable locating body 100 and the audio playing body 200 are configured as two separatable components, modularization is achieved, and GPS function and audio playing function are configured at the same time. The user may determine whether or not to perform the audio playing function according to actual needs, such that flexibility of the device is improved. Even when the audio playing body 200 is not present, the portable locating body 100 still operates independently to provide the locating and the map displaying function to meet basic needs of the user. By arranging wired connection, signal interference and connection instability, which may occur with wireless connections, may be avoided, ensuring smoothness and reliable of transmitting the audio data. Especially in the golf course, the device assists a player to be aware of: a location of the player, the distance from the golf ball to the golf hole, and a location of a hazard region in the golf course, such that playing experience is improved.

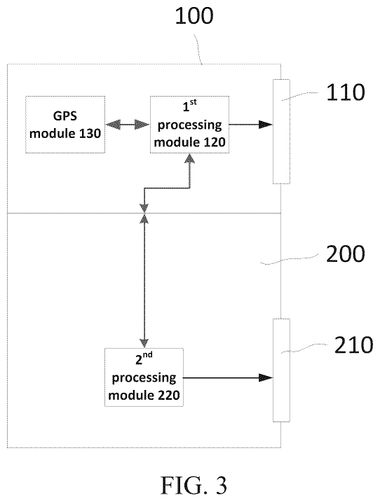

In the present embodiment, the first processing module 120 is configured to: receive the GPS locating information, such as the latitude and longitude coordinates, provided by the GPS module 130; and match the GPS locating information with the pre-stored or downloaded map information to generate the locating marker and displayed map content required by the user. The first processing module 120 is configured to: process the abovementioned information data to form corresponding audio data, including: reading a stored audio file or generating an audio prompt related to the locating information; and transmit the audio data to the audio playing body 200. The first processing module 120 controls the display module 110 to display the map information, the locating marker, and other related information; and supports the user to perform interactive operations via the touch screen. When the audio playing body 200 is connected to the portable locating body 100 via the wired connection, the first processing module 120 establishes communication with the second processing module 220 of the audio playing body 200 to ensure stable transmission of the audio data. Specifically, as shown in FIG. 3, the processing module 120 is connected, after being disposed near the audio playing body 200, to the audio playing body 200, such that wired connection between the two processing modules is achieved to achieve electrical energy transmission and data interaction.

Further, the first processing module 120 is usually configured as a high-performance microcontroller or a more advanced ARM architecture chip, which has low power consumption and high performance. The first processing module 120 performs data communication with the GPS module 130 and the display module 110 through a serial port or other interfaces to ensure cooperative operations of the modules. The first processing module 120, serving as the “brain” of the portable locating-enabled audio playing device, coordinates operations of various modules to ensure the functions of the device, such as locating, displaying, and audio playing to be achieved properly. Especially, the first processing module 120 ensures quick recognition and communication connection establishment with the audio playing body 200, such that audio can be played via the audio playing body 200.

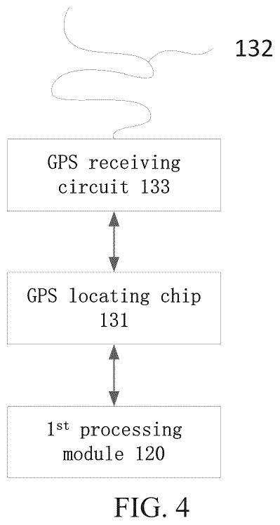

In the present embodiment, as shown in FIG. 4, the GPS module 130 includes a GPS antenna 132 and a GPS locating chip 131, and a GPS receiving circuit 133 may further be included. The GPS locating chip 131 calculates, based on radio signals, location information such as latitudes and longitudes, and altitudes. In some embodiments, the location information is obtained based on triangulation measurement. The GPS antenna 132 is configured to receive the radio signals from GPS satellites, and the location information includes position and time information of the satellites. The GPS receiving circuit 133 is disposed between the GPS antenna 132 and the GPS locating chip 131 and is configured to amplify, filter, and demodulate the signals received by the GPS antenna 132, so as to extract valid GPS signals.

The GPS location chip 131 is a core component of the GPS module and is configured to process the signals sent from the GPS receiving circuit 133. The received satellite signals are decoded to extract the position and time information of the satellites, and a distance between the device and the satellites is determined by calculating a propagation time difference of the signals. Mathematical algorithms such as the triangulation measurement are performed, by combining distance information relating to at least four satellites, to calculate a precise location of the device, including the latitudes and longitudes, and the altitudes.

The GPS locating chip 131 further has an anti-interference capability to improve accuracy and reliability of locating and integrates more functions such as an RF front-end, baseband processing, a microprocessor, and so on.

The GPS receiving circuit 133 is disposed between the GPS antenna 132 and the GPS locating chip 131 and is configured to pre-process the signals received by the GPS antenna 132 and to amplify the weak satellite signals to improve strength of the signals. External interference carried in the signals is filtered by a filter, ensuring purity of the signals. Finally, the signals are demodulated to be converted into a format suitable to be processed by the GPS locating chip 131.

The GPS receiving circuit 133 usually includes a low noise amplifier (LNA), a bandpass filter, and an RF front-end chip. The RF front-end chip down-converts high-frequency satellite signals to intermediate frequence (IF) signals, facilitating subsequent digital signal processing. Alternatively, a high-precision temperature-compensated crystal oscillator (TCXO) may be configured to provide a stable clock signal to ensure accuracy of signal processing.

In the golf course, the GPS module 130 requires higher locating accuracy. On the one hand, based on the triangulation measurement and the distance information relating to at least four satellites, the GPS module 130 may provide high precision locating services at a decimeter level or even a centimeter level. In is critically important for the player to be aware of the precise distance between the player and the golf hole and the precise distance between the player and the hazard region. On the other hand, the locating may be optimized by combining with a local network. That is, locating performed by the GPS module 130 is assisted via the local network (such as Wi-Fi or Bluetooth), such that precision of the locating is significantly improved. For example, a plurality of Wi-Fi hotspots or Bluetooth beacons may be arranged in the golf course, the GPS module 130 may further optimize a locating result by combining local network signals from the plurality of Wi-Fi hotspots or Bluetooth beacons.

Furthermore, the locating information obtained by the GPS module 130 is matched with the pre-stored map information of the golf course to ensure that the locating marker seen by the player on the display module is accurate. In order to improve accuracy and reliability of locating, the GPS locating chip 131 has the anti-interference capability and can maintain stable locating performance in complex golf course environments (such as blockage by trees or signal reflection).

Further, the locating data obtained by the GPS module 130 can be used to analyze behavioral data of the player, such as a movement trajectory, a hitting frequency, and a staying time length of the player. In this way, a court manager may optimize a court layout, adjust a lawn maintenance plan, and provide customized member services. Moreover, in the case of inclement weather or other emergencies, the GPS module 130 can quickly locate the location of the player to assist the court manager to take measures in time to ensure safety of the player.

In the present embodiment, the display module 110 may be an LCD, a LED display or an OLED display, which has an ideal displaying effect and color reproduction. The LCD controls transmittance of light based on changes in an arrangement of liquid crystal molecules to achieve image display. A back light source is needed to provide light, and a liquid crystal layer is configured to regulate brightness of the light and a color of the light. The LED is formed of a plurality of light-emitting diodes. Each of the plurality of light-emitting diodes can independently emit light, and image displaying is achieved by controlling brightness and a color of each LED. The OLED display is formed of a light-emitting layer made of organic materials, and each pixel can independently emit light without any back light source.

In the present embodiment, the second processing module 220, being similar to the first processing module 120, is a processing chip. The second processing module 220 establishes communication with the first processing module 120 of the portable locating body 100 via wired connection. The second processing module 220 receives audio data transmitted from the first processing module 120. The audio data includes the pre-stored audio file and an audio prompt relating to the locating information, such as prompts of the distance to the golf hole and the distance to the hazard region. The second processing module 220 controls the second playing module 210 to play the audio and adjusts audio playing parameters, such as audio prompts, background music, and so on, based on a type of the received audio data, ensuring clarity and smoothness of the audio output from the second playing module 210.

When the portable locating body 100 is connected to the audio playing body 200, the second processing module 220 operates cooperatively with the first processing module 120 to ensure the audio data to be stably transmitted and to be played in real time. The second processing module 220 is further configured to process potential communication errors or data loss to ensure the audio to be played continuously. When the audio playing body 200 is separated from the portable locating body 100, the second processing module 220 may operate independently to play the pre-stored audio file or obtain the audio data through other devices (such as a Bluetooth audio source).

In the present embodiment, the second audio playing module 210 receives audio signals from the second processing module 220; amplifies, by a built-in amplifier circuit, the audio signals to a level suitable to be played; and plays the amplified audio signals through a loudspeaker. The amplifier circuit is a core component configured to amplify a power of a weak audio signal to a high power, so as to drive the loudspeaker to output a sound. The loudspeaker converts an electrical signal into the sound through electromagnetic induction and vibration, such that the sound can be ultimately received by human ears. The above components work cooperatively to ensure the high-quality audio to be output.

In the present embodiment, detachable connection between the portable locating body 100 and the audio playing body 200 and the wired connection between portable locating body 100 and the audio playing body 200 substantially includes structural connection and circuit connection. In regard to the structural connection, the portable locating body 100 may be structurally connected to the audio playing body 200 via magnetic adsorption, snapping, placing into slots, and so on. In this way, the portable locating body 100 can be stably fixed to the audio playing body 200. Of course, the structural connection therebetween can alternatively be achieved through a USB interface. In addition to the fixed connection, contact electrical connection or electrical connection via the USB interface is achieved, and the USB interface includes a USBA interface, a type C interface, and so on.

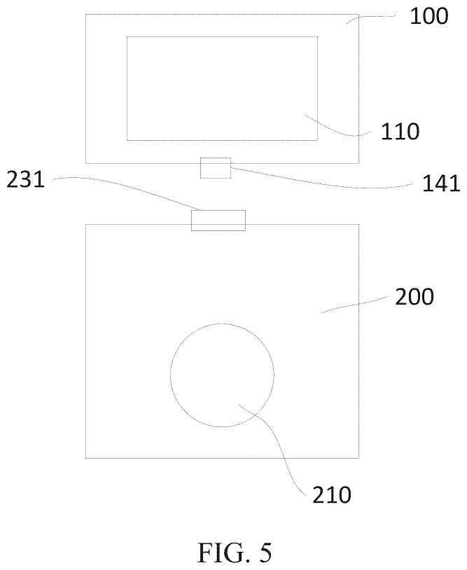

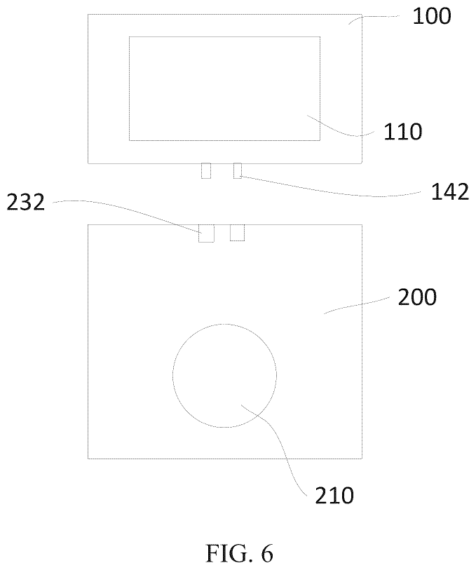

As shown in FIG. 6, the contact electrical connection refers to electrical connection through metal contacts. For example, a contact 142 is arranged on the portable locating body 100, and a contact groove 232 is defined in the audio playing body 200 and is mated with the contact 142. After inserting the contact 142 into the contact groove 232, contact is formed between the contact 142 and the contact groove 232, so as to form the electrical connection. As shown in FIG. 5, the USB interface may be configured for both structural connection and the circuit connection. The portable locating body 100 and the audio playing body 200 can perform data transmission and power management through the USB interface. For example, a USB male connector 141 may be arranged on the portable locating body 100, and a USB female chassis 231 may be arranged on the audio playing body 200 and mated with the USB male connector 141, such as a USBA male connector and a USB female chassis; or a type C male connector and a type C female chassis; or a lightning male connector and a lightning female chassis.

In the present embodiment, the portable locating-enabled audio playing device obtains accurate locating information through the GPS module 130, matches the locating information with the pre-stored or downloaded map information, and displays the current location and navigation markers in real time on the display. The GPS module 130 continuously obtains updated locating information. The first processing module 120 dynamically adjusts, based on the updated locating information, the contents of the audio prompt, such as the change in the distance to the golf hole, ensuring that the user obtains latest navigation information.

The portable locating body 100 and the audio playing body 200 are detachably connected to each other, such that the audio playing function can be selectively performed according to actual needs. In order to improve flexibility of the device, even when the audio playing body 200 is not present, the portable locating body 100 can still operate independently to provide locating and map displaying functions. By wired connection (such as connection via the USB interface or contact electrical connection), signal interference and connection instability caused by wireless connection may be avoided, ensuring smoothness and reliability of audio data transmission, and therefore, the device is particularly suitable for outdoor application scenarios, such as golf courses.

In the present embodiment, the second processing module 220 and the first processing module 120 further transmit the information data via wireless connection. The second processing module 220 and the first processing module 120 transmit the information data not only via the wired connection but also via the wireless connection. The wireless connection provides greater flexibility and convenience, and therefore, the user does not need to frequently plug and unplug a connecting wire while using the device, such that the user experience is improved.

The wireless connection may be achieved in various ways, such as Bluetooth, Wi-Fi, ZigBee and so on. The Bluetooth connection is suitable for short-range data transmission, has low power consumption and can be achieved easily. Therefore, Bluetooth connection is suitable for data transmission between portable devices. The Wi-Fi connection is suitable for data transmission at a relatively longer range. The Wi-Fi connection provides a higher data transmission rate and is suitable for data synchronization and updating in complex environments. The ZigBee connection is suitable for connection of IoT devices having lower power consumption and at a long range. The ZigBee connection is suitable to be used in golf courses and other large-area locations.

Through the wireless connection, the second processing module 220 may obtain the information data transmitted by the first processing module 120 in real time, and the information data include GPS positioning information, map information, audio files, and the like. At the same time, the second processing module 220 may also feedback processed audio data and state data of the audio playing body to the first processing module 120, such that bidirectional data transmission is achieved. In this way, an efficiency of data transmission is increased, and the device is more portable and can be used more flexibly.

Further, the second processing module 220 transmits the audio data and the state data of the audio playing body to the first processing module 120 via the wireless connection, and the first processing module 120 transmits the playing control signals for controlling the second playing module and course broadcast data to the second processing module 220 via the wireless connection. The bidirectional data transmission allows interaction between the devices to be more intelligent and efficient.

The second processing module 220 can obtain the playing control signals and the course broadcast data transmitted by the first processing module 120 in real time. For example, when the user needs to know a current position and a distance from the current position to the hole on the golf course, the first processing module 120 may generate corresponding voice prompts based on the GPS positioning information and the map information and transmit voice prompt data to the second processing module 220 through the wireless connection. The second processing module 220, after receiving the above data, may immediately control the second playing module to play the voice prompts to provide real-time voice navigation for the user.

At the same time, the second processing module 220 may further transmit the audio data and the state data of the audio playing body to the first processing module 120 via the wireless connection. For example, when a power level of the audio playing body is low, the second processing module 220 may transmit the state data to the first processing module 120 in time, and the first processing module 120, after receiving the state data, may prompt the user on the display module and activate a low-battery mode or remind the user to charge the battery in time as needed.

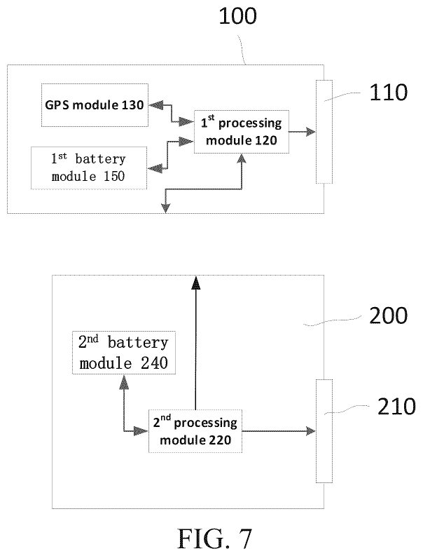

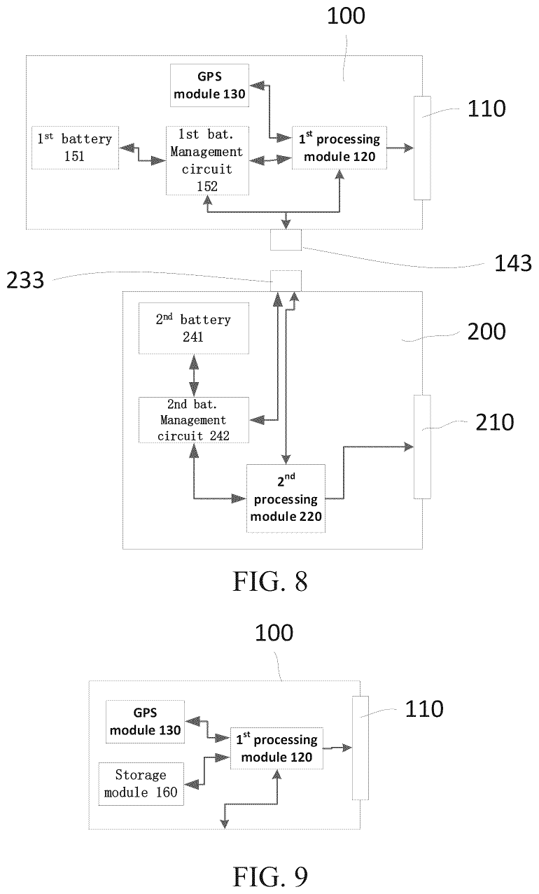

As shown in FIGS. 7 and 8, the present disclosure provides the portable locating-enabled audio playing device arranged with a first battery module 150 and a second battery module 240.

The portable locating body 100 includes the first battery module 150, the audio playing body 200 includes the second battery module 240. The second battery module 240 charges the first battery module 150 when the audio playing body 200 and the portable locating body 100 are connected to each other.

Specifically, the first battery module 150 is disposed in the portable locating body 100 to supply power to various functional modules of the portable locating body 100, such as the GPS module 130, the display module 110, the first processing module 120, and so on. The second battery module 240 is disposed in the audio playing body 200 to supply power to various modules of the audio playing body 200, such as the second processing module 220, the second playing module 210, and so on. When the audio playing body 200 is electrically connected to the portable locating body 100 via the wired connection, such as via the USB port or the contact electrical connection, the second battery module 240 charges the first battery module 150 under control of the second processing module 220.

In the present embodiment, when the audio playing body 200 is connected to the portable locating body 100, communicative connection is established between the second processing module 220 and the first processing module 120. The first processing module 120 obtains a power level of the first battery module 150 and notifies the second processing module 220. When the first battery module 150 is not fully charged, the second processing module 220 controls the second battery module 240 to charge the first battery module 150. When the first battery module 150 is fully charged, the second battery module 240 stops charging the first battery module 150. By charging the first battery module 150 through the second battery module 240, a usage time length of the portable locating body 100 is prolonged, especially in scenarios such as golf courses and outdoor adventures, the user may charge the portable locating body 100 at any time to ensure the device to operate continuously.

In the present embodiment, the first battery module 150 includes a first power management circuit 152 and a first battery 151. The second battery module 240 includes a second power management circuit 242 and a second battery 241. The portable locating body 100 includes a first interface 143, the audio playing body 200 includes a second interface 233. When the audio playing body 200 and the portable locating body 100 are connected to each other, the first interface 143 is mated, by direct or indirect plugging, with the second interface 233. The second power management circuit 242 transmits electrical energy of the second battery 241 through the second interface 233 and the first interface 143 to the first power management circuit 152. The first power management circuit 152 supplies power to the first battery 151.

Specifically, the first power management circuit 152 is configured to manage a charging and discharging process of the first battery 151, ensuring the first battery 151 to be used safely, such that the charging process is accurately controlled by detecting parameters such as a battery voltage and a battery current, and overcharging can be avoided. The battery power can be reasonably distributed to the various functional modules of the portable locating body 100. The second power management circuit 242 is configured to manage the charging and discharging process of the second battery 241 and to supply power to an external device and the portable locating body 100, converting the electrical energy of the second battery 241 into a voltage and a current suitable for the first battery module 150.

The first interface 143, disposed on the portable locating body 100, is configured to be connected with the second interface 233 of the audio playing body 200, achieving electrical energy transmission and data communication. The first interface 143 may be the USB interface (such as the Type-C interface), a dedicated charging interface, or a contact type interface. The second interface 233, arranged on the audio playing body 200, is configured to be connected with the first interface 143 of the portable locating body 100 to achieve the electrical energy transmission and data communication. The second interface 233 matches with the first interface 143, which may be the USB interface (such as the Type-C interface), the dedicated charging interface, or the contact type interface. When the audio playing body 200 is connected to the portable locating body 100, the first interface 143 is mated with the second interface 233 to achieve direct or indirect plugging connection. The plugging connection may be physical plugging (such as the USB interface) or indirect connection via a data cable. After connection, the second power management circuit 242 transmits, through the second interface 233 and the first interface 143, the electrical energy from the second battery 241 to the first power management circuit 152. During transmission, the second power management circuit 242 is configured to convert the electrical energy into the voltage and the current suitable for the first battery module 150.

In the present embodiment, each of the first power management circuit 152 and the second power management circuit 242 is a charging management chip. The charging management chip is a core of the power management circuit and is configured to control a charging current and a charging voltage and to protect the battery from overcharging and overdischarging. In the first power management circuit 152 and the second power management circuit 242, the charging management chip can accurately control the charging process to ensure the battery to be used safely. In the second power management circuit 242, the electrical energy is converted into the voltage and the current suitable for the first battery module 150, ensuring the electrical energy to be transmitted efficiently and stably.

In the present embodiment, when the audio playing body 200 is connected to the portable locating body 100, the second battery module 240 charges the first battery module 150, such that the use time length of the device is significantly extended. In scenarios such as golf courses and outdoor adventures, continuous operation of the device is critical, and by applying real-time charging, it is ensured that the device always has sufficient power level when being used for a long period of time, preventing usage interruption due to insufficient power. Even when the audio playing body 200 is not present, the portable locating body 100 can still operate independently, providing locating and map displaying functions. It may be determined whether or not to carry the audio playing body 200 according to actual needs, further improving the portability of the device. The audio playing body 200 may charge the portable locating body 100 and independently play audio files or obtain audio data through other devices (such as the Bluetooth audio source), improving multifunctionality of the device.

As shown in FIG. 9, the present disclosure provides the portable locating-enabled audio playing device arranged with a storage module 160.

The portable locating body 100 further includes the storage module 160 connected to the first processing module 120. The storage module 160 pre-stores or downloads the map information and the audio data of the golf course. The map information includes at least overall map information of the golf course, golf-hole location information and hazard-region location information.

Specifically, the storage module 160 is connected to the first processing module 120 to store and manage following two types of data: map information of the golf course and the audio data. The map information includes at least the overall map information of the golf course, the golf-hole location information and the hazard-region location information. The audio data includes pre-stored audio files, audio prompts related to the locating information and the like.

Of course, the audio playing body 200 may be arranged with a corresponding storage module 160 for data storage to achieve the independent audio playing. The storage module 160 pre-stores the overall map information of the golf course, including the golf-hole location information and the hazard-region location information, so as to enable the display module 110 to display the current location and navigation. Furthermore, the user may download the latest map information to the storage module 160 via the external terminal device 300 (such as a mobile application) to ensure accuracy and timeliness of map data.

The storage module 160 pre-stores the audio data related to the golf course, such as the audio prompts, background music, and so on. In addition, the user may download the audio data to the storage module 160 via the external device (such as the mobile application), and the downloaded audio data may be stored locally so as to be invoked at any time during use.

In the present embodiment, the storage module 160 may be a non-volatile storage medium such as a flash memory (such as a NAND Flash) or an EEPROM to ensure that the data is not lost when power failure. The storage module 160 supports reading and writing operations of the data and has a low power consumption, so as to extend the running time length of the device. In the golf course, the map information and the audio data in the storage module 160 provide real-time locating and navigation services for the player, assisting the player to understand the current location, the distances to the golf-hole, and the location of the hazard regions.

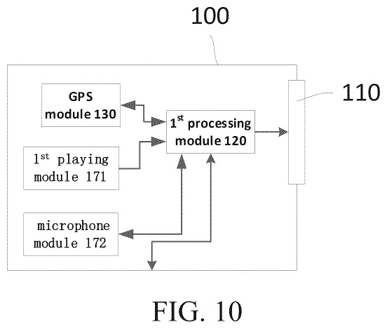

As shown in FIG. 10, the present disclosure provides the portable locating-enabled audio playing device arranged with a first playing module 171 and a microphone module 172.

The portable locating body 100 further includes the first playing module 171 and the microphone module 172 that are connected to the first processing module 120. The first processing module 120 controls the first playing module 171 to play the audio data. The audio data includes at least one of an audio file, GPS audio information corresponding to the GPS locating information, and map audio information corresponding to the map information.

In the present embodiment, the first playing module 171 plays the audio data according to instructions of the first processing module 120. The audio data may include: the audio file, the GPS audio information, and the map audio information. The audio file is a pre-stored audio file, such as background music, audio prompts, and so on. The GPS audio information is audio prompts related to the GPS locating information, such as an audio of “100 meters to the golf-hole” or “the hazard region is 50 meters in the front”. The map audio information is audio prompts relating to the map information, such as an audio of “you have entered the hazard region, please pay attention”.

The first playing module 171 has a built-in audio amplifier to amplify the processed audio signal to the level suitable for being played. In the golf course, the first playing module 171 may play audio prompts related to the locating information to assist the player to understand the current location and the distance to the golf-hole.

In the present embodiment, the microphone module 172 is configured to collect audio input to provide voice interaction functions to the user. Specifically, the microphone module 172 functions cooperatively with the first processing module 120 to achieve audio command recognition, and the user may operate the device through an audio command, such as querying the current location, playing an audio file, and so on. Audio recording may also be achieved to record audio information of the user for subsequent analysis or storage. In order to further achieve audio interaction, the microphone module 172 may cooperate with an external device (such as a mobile terminal) to achieve audio interaction, such as audio navigation or audio broadcasting.

The first processing module 120, serving as the core of the portable locating body 100, is configured to coordinate operations of the first playing module 171 and the microphone module 172. The first processing module 120 controls the first playing module 171 to play the corresponding audio data according to user demands or a state of the device. The first processing module 120 receives the audio signals collected by the microphone module 172, performs audio recognition and processing, performs the user command or provides audio feedback. The first processing module 120 manages storage and reading of the audio data to ensure smoothness of audio playing and audio interaction. Based on the audio interaction and audio playing functions, the user may obtain information without viewing the display, such that the device can be used more conveniently and safely. The first processing module 120 is configured to dynamically adjust the contents of the audio prompt according to real-time GPS locating information and the map information, ensuring that the user obtains latest information.

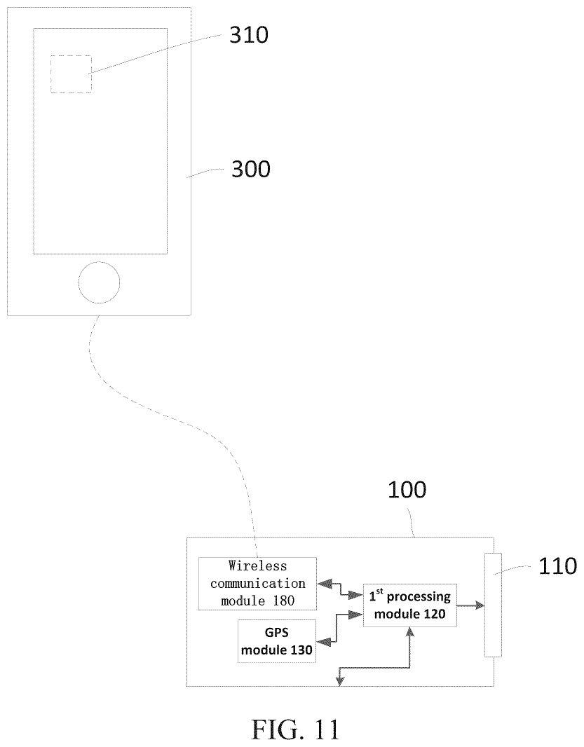

As shown in FIG. 11, the present disclosure provides the portable locating-enabled audio playing device arranged with a wireless communication module 180 and a portable locating system.

The portable locating body 100 further includes the wireless communication module 180 connected to the first processing module 120. The first processing module 120 is connected to the external terminal device 300 via the wireless communication module 180.

The wireless communication module 180 establishes, via wireless signals, connection with the external terminal device 300, such as a smartphone, a tablet computer, or other intelligent devices, so as to achieve data transmission and communication. The wireless communication module 180 transmits the locating information, the map information, and the audio data obtained by the portable locating body 100 to the external terminal device 300. Furthermore, the wireless communication module 180 receives commands sent by the external terminal device 300, such as updating the map information, playing the audio data, and so on; and supports real-time data interaction to ensure that the locating information is updated in real time, and the audio data is transmitted smoothly.

The wireless communication module 180 may have a variety of communication methods, as follows.

The wireless communication module 180 may communicate via Wi-Fi communication, supporting Wi-Fi connection in a 2.4 GHz or 5GHz band and establishing a communication link with the external device through a standard Wi-Fi protocol.

The wireless communication module 180 may communicate via Bluetooth communication, supporting Bluetooth 4.0 or higher version, suitable for short-range and low-power communication,

The wireless communication module 180 may communicate via cellular network communication, supporting 2G, 4G or 5G networks, and wide-area network communication can be achieved via operator networks.

The wireless communication module 180 may communicate via other wireless technologies, some modules of the device may support LoRa, Ultra Wide Band (UWB), and other technologies for high-precision locating or low-power and long-distance communication.

In the present embodiment, the portable locating system is provided, the portable locating system includes the portable locating-enabled audio playing device and the external terminal device 300. The portable locating body 100 of the portable locating-enabled audio playing device is connected to the external terminal device 300 via the wireless communication module 180.

Two communication systems may be arranged, which include a short-range communication system and a long-range communication system.

In the short-range communication system, the wireless communication module 180 may be a Bluetooth module, and the external terminal device 300 may be a smartphone, a tablet computer, or a dedicated monitoring terminal, which is in Bluetooth communication with the portable locating-enabled audio playing device for data interaction. In the long-range communication system, the wireless communication module 180 may be cellular network communication, and the external terminal device 300 may be a server, which is configured to store and process a large amount of locating data to support multi-user access and data sharing.

The portable locating-enabled audio playing device supports a variety of locating technologies, such as GPS, BeiDou, UWB, and so on, such that, the device may be applicable in various application scenarios. For example, the GPS or the BeiDou is used for locating in outdoors, and the UWB is used for high-precision locating in indoors. Target locating information (such as latitudes and longitudes, altitudes, a speed, and so on) is obtained through the locating module, and the locating information may be updated in real time. The portable locating-enabled audio playing device establishes connection with the external terminal device 300 or the server via the wireless communication module 180 (such as Wi-Fi, Bluetooth, GPRS, 4G/5G, and so on) to achieve real-time data transmission. Furthermore, in order to ensure data security, the system supports encrypted data transmission to prevent information leakage. The external terminal device 300 receives locating data from the portable locating-enabled audio playing device and displays the target location on a map in real time, and the user may send commands, such as updating the map information, adjusting a locating frequency, and so on, through a terminal device. The server is configured to store a large amount of locating data, support historical data query and analysis, and support simultaneous access by a plurality of terminal devices, facilitating teamwork or remote monitoring.

In the present embodiment, the portable locating body 100 is connected to a mobile terminal, which serves as the external terminal device 300, via a Bluetooth module, which serves as the wireless communication module 180. The mobile terminal is installed with a management application 310 based on the golf course, and the mobile terminal transmits golf-playing information of the management application 310 to the portable locating body 100.

Specifically, the management application 310 supports functions such as course information query, golf-playing records, and score management.

During playing golf, the management application 310 updates the golf-playing information in real time based on the location of the player and hitting situations of the player; and transmits the golf-playing information to the portable locating body 100 via the Bluetooth module. The player obtains the course information via the management application 310 on the mobile terminal and transmits the course information to the portable locating body 100 via the Bluetooth module, such that real-time navigation and playing records are achieved. The management application 310 provides the course information and supports other functions such as recording golf-playing records and data analysis.

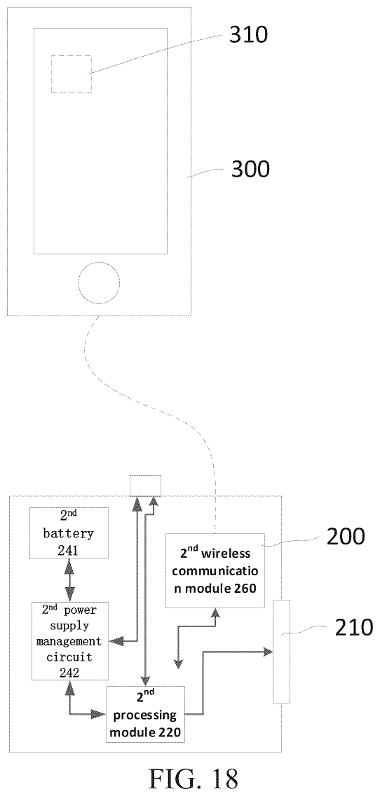

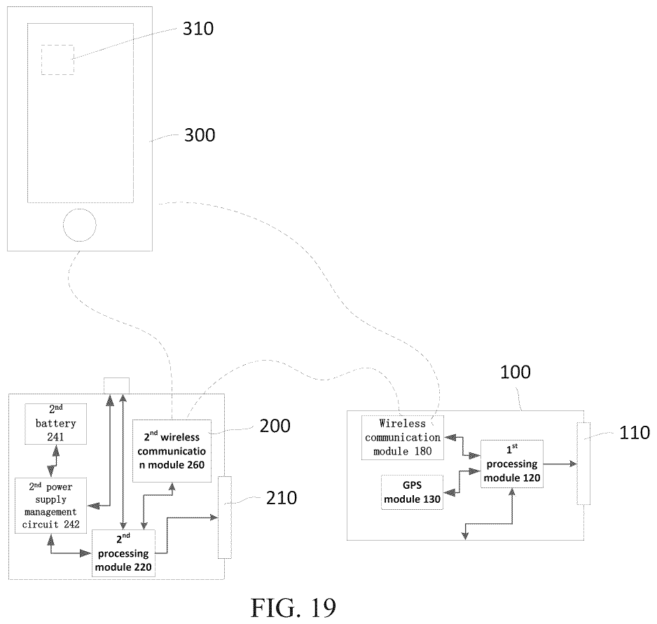

In the present embodiment, as shown in FIGS. 18 and 19, the portable positioning body 100 synchronizes match data to the external terminal device 300 via wireless transmission; and the external terminal device 300 updates the map information and/or the time information to the portable positioning body 100 via wireless transmission.

During synchronizing the match data, the portable positioning body 100 synchronizes the match data, including the number of strikes of a player, a distance of each strike, a current position, time of the match, and the like, to the external terminal device 300 via the wireless transmission. The data may be uploaded to the external terminal device 300 in real time so as to facilitate the player and the coach to perform analysis and recording. For example, the player may view his match performance via the external terminal device 300, and the coach may remotely monitor the position of the player and a match progress. During updating the map information, the external terminal device 300 updates the map information and the time information to the portable positioning body 100 via the wireless transmission, and the updated map information includes a new map of the golf course, an adjustment of obstacle areas, a change in a position of any hole, and so on. Updating the time information includes updating the current time, updating the time of the match, updating weather information, and so on. Therefore, it is ensured that the map information and the time information are always up-to-date to avoid navigation errors caused by outdated information.

Further, the audio playing body 200 of the portable locating-enabled audio playing device is connected to the external terminal device 300 via the wireless transmission and transmits audio data. The audio playing body 200 is connected to the external terminal device 300 via the wireless transmission and obtains audio data on the external terminal device 300 in real time, such as background music, voice prompts, and the like. Moreover, the audio data are stored in a storage module of the audio playing body 200 or are played directly through the audio playing body 200.

The audio playing body 200 is arranged with a second wireless communication module 260 built therein, and the second wireless communication module 260 is connected to the second processing module 220. The second processing module 220 is communicatively connected to the external terminal device 300 and the wireless communication module 180 of the portable locating body 100 via the second wireless communication module 260. In this way, mutual communication among the portable locating body 100, the audio playing body 200, and the external terminal device 300 is achieved.

Further, the external terminal device 300 is arranged with a playing interface or/and a playing key, the external terminal device 300 initiates a playing operation through the playing interface or/and the playing key and firstly sends playing control signals to the audio playing body 200. The audio playing body 200 feeds back to the external terminal device 300 after processing is completed. Alternatively, the portable locating body 100 is arranged with a playing interface and/or a playing button, the portable positioning body 100 initiates a playing operation via the playing interface and/or the playing button and firstly sends the playing control signals to the audio playing body 200. The audio playing body 200 feeds back to the portable locating body 100 and the external terminal device 300 after processing is completed.

Specifically, the external terminal device 300 is arranged with a playing interface or a playing key. The user may initiate a playing operation through the playing interface or the playing key. The external terminal device 300 sends the playing control signals to the audio playing body 200. The audio playing body 200 receives the playing control signals, processes the playing control signals, and feeds back results of the processing to the external terminal device 300. For example, the user may select an audio file to be played on a mobile phone or a tablet computer and send the playing control signals to the audio playing body 200 via Bluetooth or Wi-Fi. The audio playing body 200 receives the playing control signal, starts playing the selected audio file, and feeds a playing status back to the external terminal device 300.

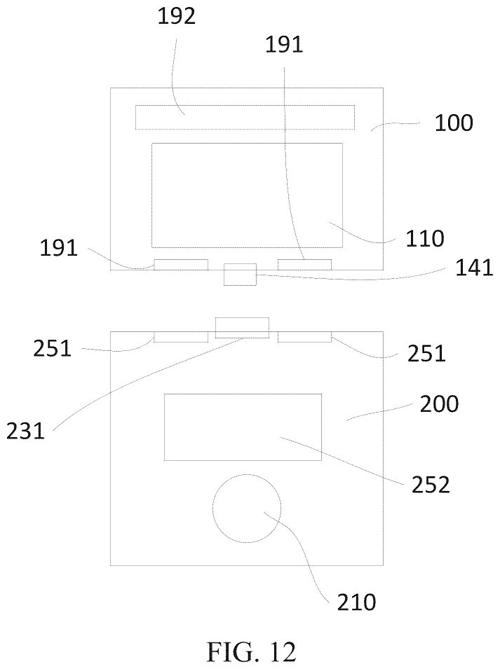

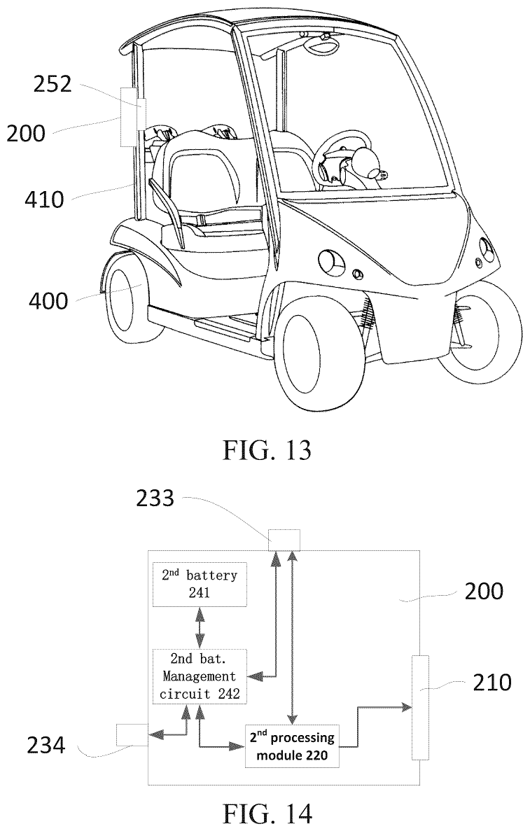

As shown in FIGS. 12 and 13, the present disclosure provides the portable locating-enabled audio playing device arranged with a magnetic adsorption structure.

The magnetic adsorption structure is disposed between the portable locating body 100 and the audio playing body 200. The portable locating body 100 is magnetically connected to the audio playing body 200 through the magnetic adsorption structure.

Each of the portable locating body 100 and the audio playing body 200 are arranged with a built-in strong magnet. In some embodiments, the magnet is made of a high-performance neodymium iron boron material, having a large adsorption force. The user can connect the portable locating body 100 with the audio playing body 200 or separate the portable locating body 100 from the audio playing body 200 by performing a simple contact operation. The magnetic adsorption structure, while in use, maintains stable connection between the portable locating body 100 and the audio playing body 200, and the portable locating body 100 and the audio playing body 200 may not be easily separated from each other even in bumpy or vibrating situations (such as when the golf cart is traveling).

In some embodiments, the magnetic adsorption structure includes a third magnetic adsorption member 191 disposed on the portable locating body 100 and a fourth magnetic adsorption member 251 disposed on the audio playing body 200. In particular, the magnetic adsorption structure may be used cooperatively with the first interface 143 and the second interface 233. When the third magnetic adsorption member 191 and the fourth magnetic adsorption member 251 are adsorbed to each other, the portable locating body 100 and the audio playing body 200 are positioned with each other, and the first interface 143 and the second interface 233 are plugged and mated with each other. In this way, structural positioning and interface plugging and mating between the portable locating body 100 and the audio playing body 200 are achieved, communicative connection and electrical connection are achieved through the interface plugging and mating.

In the present embodiment, the magnetic adsorption can be achieved in two manners.

In a first manner, the portable locating body 100 includes a first magnetic adsorption member 192, and the portable locating body 100 is magnetically adsorbed to an external metal part by the first magnetic adsorption member 192.

In a second manner, the audio playing body 200 includes a second magnetic adsorption member 252, and the audio playing body 200 is magnetically adsorbed to the external metal part by the second magnetic adsorption member 252.

Specifically, by arranging the first magnetic adsorption member 192 or the second magnetic adsorption member 252, the portable locating body 100 and the audio playing body 200 can be adsorbed to the external metal part, such as the golf cart and a golf club, such that the player, during playing golf, may view the locating information and hear audio prompts and locate, and the portable locating body 100 and the audio playing body 200 may be located at any time without being carried them on a body of the player, such that movement of the player may not be interfered. In addition to the golf cart and the golf club, the magnetic adsorption structure may be used to be adsorbed to other metal surfaces, such as metal signboard or metal railings at the golf course. Therefore, application scenarios of the device are further extended.

The magnetic adsorption structure, the first magnetic adsorption member192 and the second magnetic adsorption member 252 are arranged to improve fixation stability and portability of the device. The user may attach the device to various metal objects by the first magnetic adsorption member 192 and the second magnetic adsorption member 252 as needed at any time, and no additional brackets or fixation structures are needed.

As shown in FIG. 13, a metal pole 410 of the golf cart 400 is adsorbed to the audio playing body 200. The audio playing body 200 is adsorbed and fixed to the metal pole 410 by the second magnetic adsorption member 252. The portable locating body 100 may also be adsorbed similar to the adsorption of the audio playing body 200, or may be detachably connected to the audio playing body 200.

As shown in FIG. 14, the present disclosure provides the portable locating-enabled audio playing device arranged with a third interface 234.

The audio playing body 200 further includes a third interface 234 connected to the second battery module 240. The second battery module 240 supplies power to the external device through the third interface 234 or obtains external electrical energy for charging.

The audio playing body 200 may be connected to the portable locating body 100 via the second interface 233 and is further arranged with the third interface 234, serving as an interface for external power supply. Of course, the third interface may alternatively serve as a charging interface for the second battery module 240. The third interface 234 may be a USB interface (such as a USB-A or USB-C interface), a Micro-USB interface, or other dedicated charging interfaces.

When the second battery module 240 of the audio playing body 200 is sufficiently charged, the audio playing body 200 may supply power to external devices via the third interface 234, such as, providing emergency charging for other portable devices (such as the mobile phone, the tablet computer). When the audio playing body 200 needs to be charged, the user can connect the audio playing body 200 to an external power source (such as a charger adapter, a vehicle-mounted charger, a mobile power source) via the third interface 234 to charge the second battery module 240.

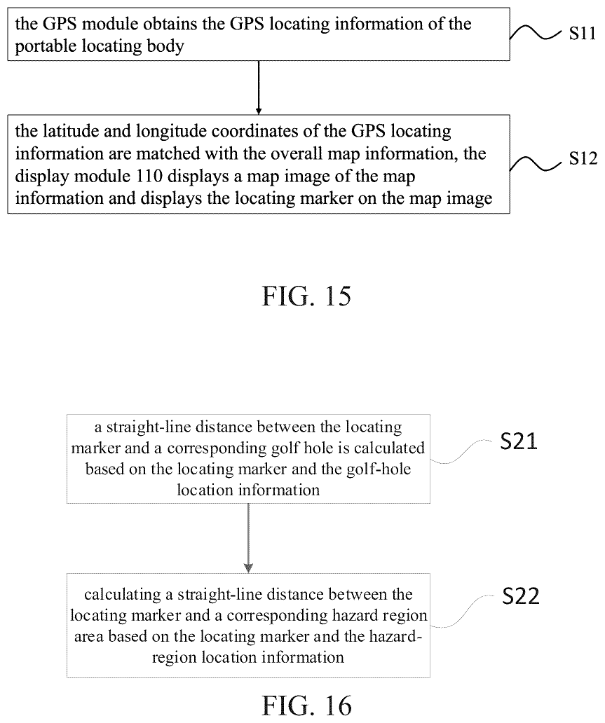

As shown in FIGS. 15 and 16, the present disclosure provides a data management method.

In the data management method based on the golf course, the portable locating body 100 pre-stores or downloads the map information of the golf course, the map information includes at least the overall map information of the golf course, the golf-hole location information, and the hazard-region location information. The data management method includes following operations.

In an operation S11, the GPS module 130 obtains the GPS locating information of the portable locating body 100.

In an operation S12, the latitude and longitude coordinates of the GPS locating information are matched with the overall map information, the display module 110 displays a map image of the map information and displays the locating marker on the map image.

Specifically, the overall map information pre-stored or downloaded by the portable locating body 100 includes a complete layout of the golf course, including distribution of fairways, greens, bunkers, water hazards, and other regions. The golf-hole location information accurately indicates a location of each golf hole, facilitating the player to rapidly locate a target. The hazard-region location information clearly indicates a location of each hazard region, such as the bunkers, water hazards, and other hazard regions, facilitating the player to avoid risks. Pre-storage is to pre-store some of the map information of a common golf course when the portable locating body 100 is out of the factory. Downloading is done by connecting with the external terminal device 300 (such as the smartphone) to download latest map data from a cloud server.

The portable locating body 100 obtains the locating information of the portable locating body 100 through the built-in GPS module 130. The GPS module 130 provides accurate latitude and longitude coordinates in real time to ensure that the location of the portable locating body 100 on the course is accurately recorded. The obtained GPS locating information (latitude and longitude coordinates) is matched with the pre-stored or downloaded map information. The map information is displayed on the display module 110, and the current location of the portable locating body 100 is marked on the map image. When the location of the portable locating body 100 is displayed on the map in a form of an icon or a marker, the player may intuitively understand the location of the player on the course.

A specific process of the method is as follows. The player may view, through the portable locating body 100, the location of the player on the course in real time, understand the distance to the golf-hole and locations of nearby hazard regions. In combination with the GPS locating information and the map information, the player is provided with real-time navigation, and a hitting strategy can be optimized. The map information can be online updated, ensuring that the player is using a latest layout of the course. Therefore, the high-precision GPS module 130 is arranged to ensure accurate and real-time locating. A high-resolution touch screen is arranged to support zoom-in, zoom-out, and rotation operations performed on the map to improve the user experience. The device is connected to the external device via the Bluetooth or Wi-Fi module to download and update the map information.

In the present embodiment, as shown in FIG. 16, the data management method further includes following operations.

In an operation S21, a straight-line distance between the locating marker and a corresponding golf hole is calculated based on the locating marker and the golf-hole location information.

Specifically, the portable locating body 100 takes the built-in first processing module 120 to calculate, based on the obtained GPS locating information and the pre-stored map information, the straight-line distance between the current location and the golf hole. The GPS module 130 obtains the latitude and longitude coordinates (X1, Y1) of the portable locating body 100 in real time, and extracts latitude and longitude coordinates (X2, Y2) of the golf hole from the map information. The calculated distance in meters or yards is displayed on the display module 110 and is informed to the player through an audio prompt.

In addition to calculating the distance to the golf-hole, the portable locating body 100 may further calculate a straight-line distance between the current location and the hazard region (such as a bunker, a water hazard, and so on) to assist the player to avoid risks in advance and to optimize the hitting strategy. The GPS module 130 obtains, in real time, the latitude and longitude coordinates (X1, Y1) of the portable locating body 100, and extracts the location information of the hazard region area from the map information. The hazard region may be a point (such as a center of the bunker) or a region having a certain area (such as a boundary of the water hazard). When the hazard region has a certain area, a nearest boundary point may be selected for calculation.

When the hazard region is the point, the distance between the current location and the center of the hazard region is calculated directly using a spherical distance calculation formula. When the hazard region has the certain area, a shortest distance from the current location to the boundary of the hazard region is calculated. Specifically, coordinates of a plurality of key points of the boundary of the hazard region are extracted. A straight-line distance between the current location and each of the plurality of key points is calculated. A smallest straight-line distance is selected as the shortest distance from the current location to the hazard region.

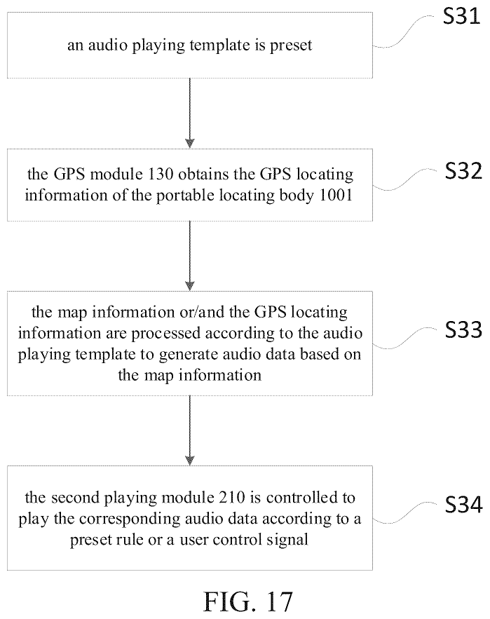

As shown in FIG. 17, the present disclosure provides a preferred embodiment of the data management method based on audio playing.

The data management method based on the golf course may be applied to the portable locating-enabled audio playing device. The portable locating body pre-stores or downloads the map information of the golf course, the map information includes at least: the overall map information of the golf course, the golf-hole location information and the hazard-region location information.

The data management method includes following operations.

In an operation S31, an audio playing template is preset.

In an operation S32, the GPS module 130 obtains the GPS locating information of the portable locating body 1001.

In an operation S33, the map information or/and the GPS locating information are processed according to the audio playing template to generate audio data based on the map information.

In an operation S34, the second playing module 210 is controlled to play the corresponding audio data according to a preset rule or a user control signal.

Specifically, the audio playing template is a predetermined audio content template. Essentially, the map information and the GPS locating information, which serve as information data, are formatted and processed based on the template, and the formatted and processed map information and the GPS locating information are converted into the audio prompt. The audio playing template may include various audio contents, such as “X meters from the golf-hole”, “a hazard region is X meters in the front”, and so on. Moreover, the template supports a plurality of languages and audio styles, which may be determined by the user according to personal preference.

In the present embodiment, the GPS module 130 is configured to obtain real-time location information of the portable locating body, including the latitude and longitude coordinates, the altitudes, and so on. In addition, according to the preset audio playing template, the map information and the GPS locating information are processed into audio data. The audio data may be the audio prompts, assisting the user to be aware of the current location, the distance from the golf-hole, and the location of the hazard region. A specific processing method is as follows.

The first processing module 120 matches the GPS locating information with the pre-stored map information; determines a position of the current location on the map; calculates the distance based on the locating marker and the golf-hole position information; and generates the corresponding audio prompt contents based on the audio playing template. A text-to-speech (TTS) technology is applied, the generated audio prompt contents are converted into audio data. The audio data may be stored in the storage module 160 of the portable locating body or directly transmitted to the audio playing body 200. As the GPS locating information is updated in real time, the audio data is dynamically adjusted to ensure the audio prompt to be accurate and in real time.

In the present embodiment, the preset rule may include a condition for automatically playing the audio prompt. For example, a distance prompt is automatically played when a certain distance from the golf-hole is reached. The rule may be customized according to various application scenarios (such as the golf course). The user may send a control signal via the touch screen or the external device 300 (such as the application of the mobile phone) to manually select the audio content to be played. The user may adjust an audio playing volume, select an audio playing style, or pause/resume audio playing.

The above description shows only preferred embodiments of the present disclosure, and the present disclosure is not limited by the above description. Any equivalent changes or modifications made based on the scope of the present disclosure are covered by the present disclosure.

What is claimed is:

1. A portable locating-enabled audio playing device, comprising:
a portable locating body, comprising a first processing module, a GPS module and a display module, wherein the GPS module is configured to obtain GPS locating information of the portable locating body; the display module is configured to display map information and the GPS locating information under control of the first processing module; the GPS locating information comprises a locating marker on the map information;
an audio playing body, detachably connected to the portable locating body, wherein the audio playing body comprises a second processing module and a second playing module; the second playing module is connected to the first processing module when the audio playing body and the portable locating body are connected to each other; the second processing module is configured to: obtain information data transmitted from the first processing module; and control the second playing module to play audio data in the information data;
wherein the second processing module transmit the information data to the first processing module.

2. The portable locating-enabled audio playing device according to claim 1, wherein the second processing module and the first processing module are configured to transmit the information data via wired connection.

3. The portable locating-enabled audio playing device according to claim 1, wherein the second processing module and the first processing module are configured to transmit the information data via wireless connection.

4. The portable locating-enabled audio playing device according to claim 3, wherein the second processing module is configured to transmit the audio data and state data of the audio playing body to the first processing module via the wireless connection; the first processing module is configured to transmit playing control signals for controlling the second playing module and course broadcast data to the second processing module via the wireless connection.

5. The portable locating-enabled audio playing device according to claim 1, wherein the portable locating body further comprises a storage module connected to the first processing module; the storage module is configured to pre-store or download the map information of a golf course; the map information comprises at least: overall map information of the golf course, golf-hole location information, and hazard-region location information.

6. The portable locating-enabled audio playing device according to claim 1, wherein the portable locating body further comprises a first playing module and a microphone module connected to the first processing module; the first processing module is configured to control the first playing module to play the audio data; and
the audio data comprises at least one of: an audio file, GPS audio information corresponding to the GPS locating information, and map audio information corresponding to the map information.

7. The portable locating-enabled audio playing device according to claim 1, wherein the portable locating body further comprises a wireless communication module connected to the first processing module; the first processing module is connected to an external terminal device via the wireless communication module.

8. The portable locating-enabled audio playing device according to claim 1, wherein the portable locating body comprises a first battery module, the audio playing body comprises a second battery module; and the second battery module charges the first battery module when the audio playing body and the portable locating body are connected to each other.

9. The portable locating-enabled audio playing device according to claim 1, wherein the first battery module comprises a first power management circuit and a first battery, the second battery module comprises a second power management circuit and a second battery; the portable locating body comprises a first interface, the audio playing body comprises a second interface;
when the audio playing body and portable locating body are connected to each other, the first interface and the second interface are mated with each other by direct or indirect plugging, the second power management circuit is configured to transmit electrical energy of the second battery through the second interface and the first interface to the first power management circuit, and the first power management circuit supplies power to the first battery.

10. The portable locating-enabled audio playing device according to claim 1, wherein a magnetic attraction structure is arranged between the portable locating body and the audio playing body; and the portable locating body is magnetically connected to the audio playing body via the magnetic attraction structure.

11. The portable locating-enabled audio playing device according to claim 1, wherein the display module of the portable locating body comprises a touch display.

12. The portable locating-enabled audio playing device according to claim 8, wherein the audio playing body further comprises a third interface connected to the second battery module, and the second battery module is configured to supply power to an external device through the third interface or obtain external electrical energy for charging.

13. The portable locating-enabled audio playing device according to claim 1, wherein the portable locating body comprises a first magnetic attraction member, the portable locating body is magnetically attracted to an external metal part through the first magnetic attraction member; or, the audio playing body comprises a second magnetic attraction member, the audio playing body is magnetically attracted to an external metal part through the second magnetic attraction member.

14. A data management method based on a golf course, performed by the portable locating-enabled audio playing device according to claim 1, wherein the portable locating body pre-stores or downloads the map information of the golf course, the map information comprises at least: overall map information of the golf course, golf-hole location information and hazard-region location information; and the data management method comprises:
obtaining, through the GPS module, the GPS positioning information of the portable locating body;
matching latitude and longitude coordinates of the GPS locating information with the overall map information;
displaying a map image of the map information in the display module and displaying the locating marker on the map image.

15. The data management method according to claim 14, further comprising:
calculating a straight line distance between the locating marker and a corresponding golf hole based on the locating marker and the golf-hole location information; and
calculating a straight-line distance between the locating marker and a corresponding hazard region area based on the locating marker and the hazard-region location information.

16. A data management method based on a golf course, performed by the portable locating-enabled audio playing device according to claim 1, wherein the portable locating body pre-stores or downloads the map information of the golf course, the map information comprises at least: the overall map information of the golf course, the golf-hole location information, and the hazard-region location information; and the data management method comprises:
presetting an audio playing template;
obtaining, through the GPS module, the GPS positioning information of the portable locating body;
processing the map information or/and the GPS locating information according to the audio playing template to form audio data based on the map information; and
controlling the second playing module to play the corresponding audio data according to a preset rule or a user control signal.

17. A portable locating system, comprising: the portable locating-enabled audio playing device according to claim 1 and an external terminal device; wherein the portable locating body of the portable locating-enabled audio playing device is connected to the external terminal device via wireless transmission.

18. The portable locating system according to claim 17, wherein, the portable locating body comprises a Bluetooth module; the external terminal device is a mobile terminal; the portable locating body is connected to the mobile terminal via the Bluetooth module; the mobile terminal is installed with a management application based on the golf course; the mobile terminal transmits golf playing information from the management application to the portable locating body.

19. The portable locating system according to claim 17, wherein the portable locating body is configured to synchronize match data to the external terminal device via wireless transmission; and the external terminal device is configured to update map information and/or time information to the portable locating body via the wireless transmission; and/or
wherein an audio playing body of the portable locating-enabled audio playing device is connected to the external terminal device via the wireless transmission and transmits audio data to the external terminal device.

20. The portable locating system according to claim 19, wherein the external terminal device is arranged with a playing interface or/and a playing key, the external terminal device is configured to initiate a playing operation through the playing interface or/and the playing key and firstly send playing control signals to the audio playing body, and the audio playing body is configured to feed back to the external terminal device after completing processing; or
the portable locating body is arranged with a playing interface or/and a playing key, the portable locating body is configured to initiate a playing operation via the playing interface or/and the playing key and firstly send the playing control signals to the audio playing body; and the audio playing body is configured to feed back to the portable locating body and the external terminal device after completing processing.
